(19) United States
(12) Patent Application Publication
(10) Pub. No.: US 2003/0105727 A1
(43) Pub. Date: Jun. 5, 2003

(54) Method and apparatus for determining patent license fees using algorithmic exposure rates

(76) Inventor: Scot A. Reader, Sherman Oaks, CA (US)

Correspondence Address: Scot A. Reader, Esq., 3424 Woodcliff Road, Sherman Oaks, CA, 91403, US

(21) Appl. No.: 10/006,951

(22) Filed: Dec. 5, 2001

(51) Int. Cl. G06G 7/00

(52) U.S. Cl. 705/400

(57) ABSTRACT

A method and apparatus for determining patent license fee data in a networked computing environment. The method and apparatus involve algorithmic determination of an exposure rate to be applied in determining the patent license fee data. The exposure rate may be determined in function of a licensor patent count, alone or in combination with other factors bearing on the strength of the licensor's patents.

### BACKGROUND OF THE INVENTION

A fee for a unilateral patent license in a technological field may be calculated by multiplying the licensee's product revenue in the field by an exposure rate in the field and a royalty rate in the field. A fee for a unilateral patent license in multiple technological fields may be calculated by summing the fees calculated as described above for the individual fields. A fee for a bilateral patent license may be calculated by performing one of the foregoing calculations, swapping the licensor and licensee, repeating the one of the foregoing calculations and subtracting the fee calculated in the second instance from the first to yield a “balancing payment”.

Patent licensing professionals may apply license fees calculated using these formulas prospectively, to determine which potential licensing targets to engage and what license fees to expect from such targets, and to determine what licensee fees others may expect from their own clients. However, the usefulness of such calculated license fees depends on the reliability of the underlying data, including corporate affiliation data, product revenue data, exposure rate data and royalty rate data. Sometimes the patent licensing professional will have sufficiently reliable data on all these subjects to make the license fee calculation with a high degree of confidence. For instance, the patent licensing professional may glean reliable product revenue data from a market study, may glean reliable exposure rate data from an infringement study and may glean reliable royalty rate data from an industry survey. But in many cases, the patent licensing professional will not have sufficiently reliable data on some or all of these subjects. For the subjects on which the patent licensing professional must engage in some degree of speculation, a computer, through the use of algorithms, may be able to provide data of superior reliability than the guesswork of the patent licensing professional.

### SUMMARY OF THE INVENTION

The present invention facilitates rational patent license fee determinations through the expedient of algorithmically determined exposure rates. In one aspect, a method for determining patent license fee data comprises: inputting on a computer patent license data; processing the patent license data using an interaction involving the computer to determine patent license fee data; and outputting on the computer the patent license fee data, wherein the processing step includes determining algorithmically exposure rate data to be applied in determining the patent license fee data.

In another aspect, a networked computing system comprises an end-user station having a user interface, for interacting with a user, and a network interface, for interacting with a network, wherein the end-user station interacts with the user and the network to determine patent license fee data including determining algorithmically exposure rate data to be applied in determining the patent license fee data.

In yet another aspect, a computer program has instructions for interacting with an end-user station, a user and a network to determine patent license fee data including determining algorithmically exposure rate data to be applied in determining the patent license fee data.

In yet another aspect, a method for determining patent license fee data comprises: identifying a patent count; calculating exposure rate data in function of the patent count; and calculating patent license fee data in function of the exposure rate data.

In yet another aspect, a method for determining exposure rate data for application in determining patent license fee data, comprises: identifying a plurality of exposure rate function parameters; defining an exposure rate function using the plurality of exposure rate function parameters; identifying a patent count; and applying the patent count in the exposure rate function to determine exposure rate data.

These and other objects of the present invention may be better understood by reference to the following detailed description, taken in conjunction with the accompanying drawings briefly described below. Of course, the actual scope of the invention is defined by the appended claims.

### BRIEF DESCRIPTION OF THE DRAWINGS

FIG. 1 illustrates a networked computing environment for use in determination of patent license fees;

FIG. 2 is a flow diagram illustrating a method for determining a unilateral patent license fee for a single technological field;

FIG. 3 is a flow diagram illustrating a method for determining a unilateral total patent license fee for multiple technological fields;

FIG. 4 is a flow diagram illustrating a method for determining a bilateral patent license fee for a single technological field;

FIG. 5 is a flow diagram illustrating a method for determining a bilateral net patent license fee for multiple technological fields;

FIG. 6 is a graphical illustration of an algorithmic exposure rate function for application in determining an algorithmic exposure rate; and

FIG. 7 is a graphical illustration of a weighted algorithmic exposure rate function for application in determining an algorithmic exposure rate.

### DETAILED DESCRIPTION OF THE PREFERRED EMBODIMENT

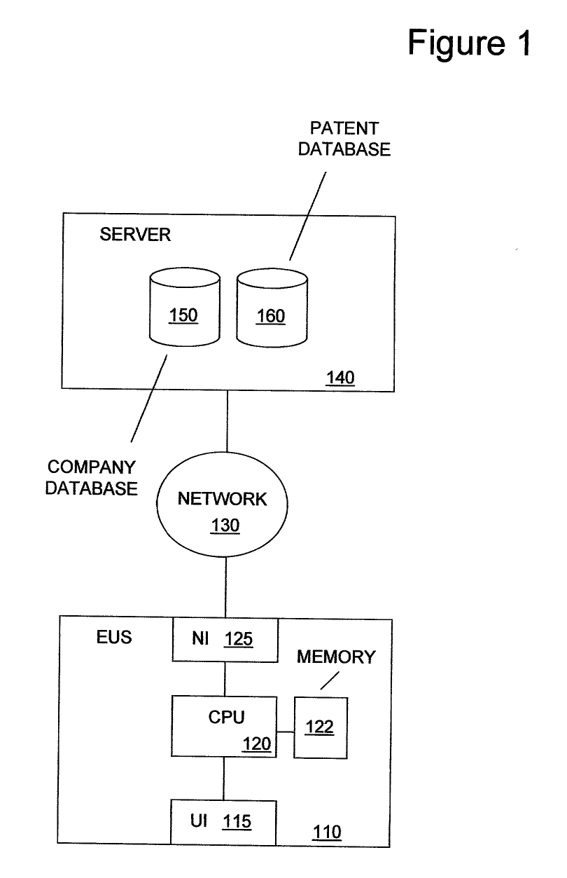

In FIG. 1, a networked computing environment for use in interactive patent license fee determination is shown. The environment includes end-user station (EUS) 110, such as a personal computer or workstation, having user interface (UI) 115, processor (CPU) 120, memory 122 and network interface (NI) 125. End-user station 110 receives and transmits data on user interface 115, processes data, in conjunction with memory 122, using processor 120 and exchanges data with server 140 over network interface 125. Network interface 125 may be a wired or wireless interface. Data exchanges are performed via network 130, such as a LAN or WAN, and involve retrieving information from company database 150 and patent database 160. Memory 122 stores data, including software program instructions for a software program loaded on end-user station 110, data input by the user and data retrieved in data exchanges. Processor 120 uses stored data, including the software program instructions, to provide functionality described herein. Particularly, functionality referenced as being performed by processor 120 involves execution of software program instructions retrieved from memory 122. Company database 150 has entries for possible licensors and licensees including lists of affiliated legal entities and global revenue data. Patent database 160 has entries for patents including patent numbers, assignee names, filing dates, grant dates, maintenance status data, patent classification numbers and patent strength indices (PSIs). The patent classification numbers may be international classification numbers or U.S. classification numbers. Patent database 160 also preferably includes royalty rates by patent classification number. Server 140 may, in addition to databases 150, 160, include processing elements applied, for instance, in interacting with databases 150, 160 to generate search results for search queries received from end-user station 110. Of course, databases 150, 160 may in other embodiments of the invention reside on different servers.

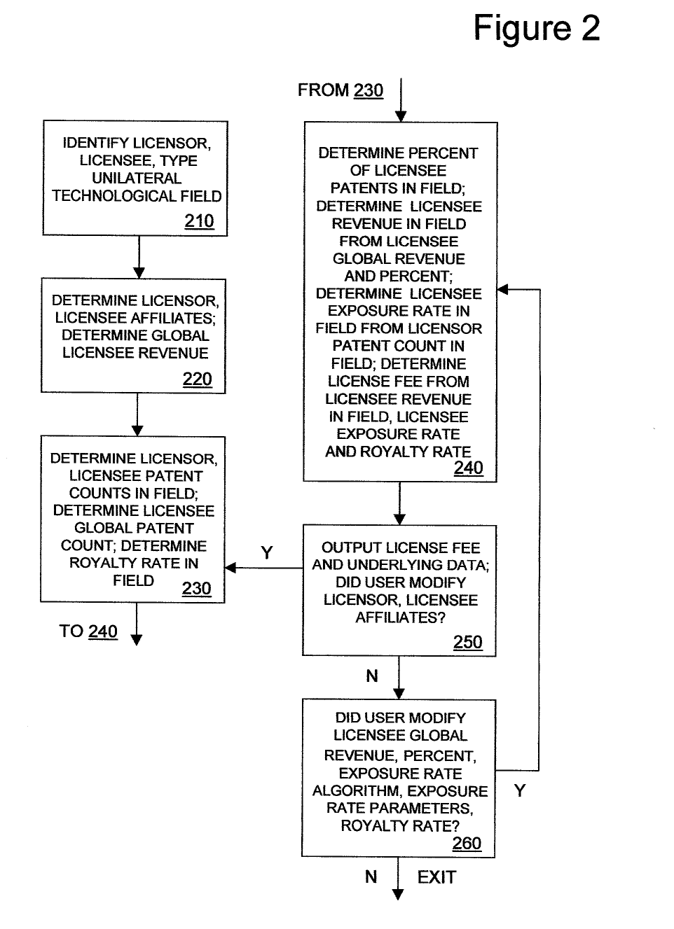

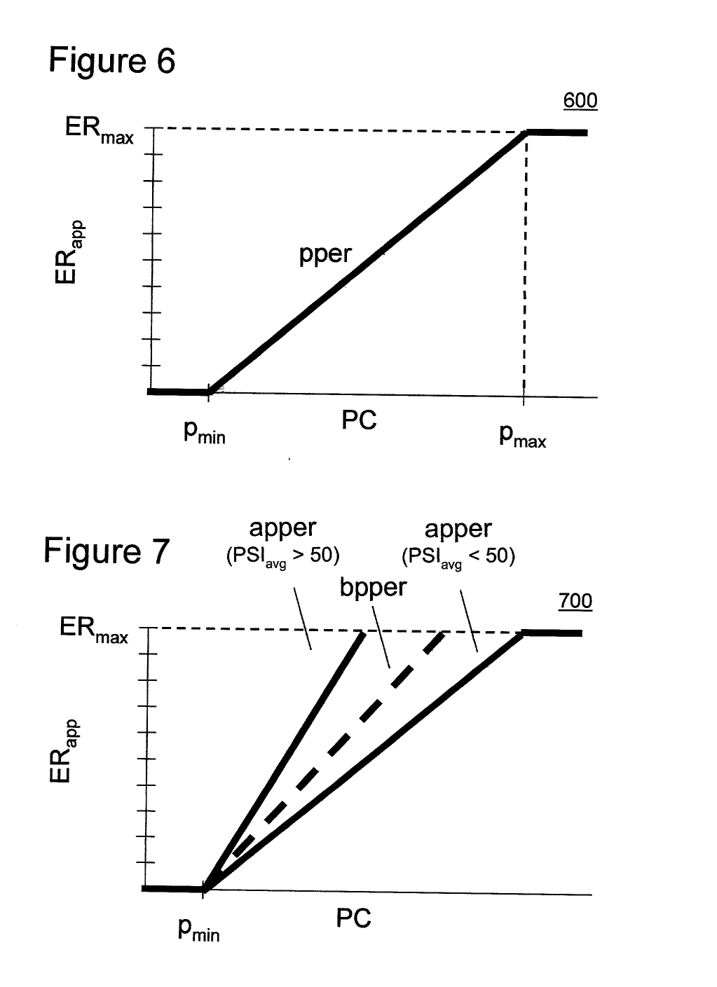

In FIG. 2, a flow diagram illustrates an interactive method for determining a unilateral patent license fee for a single technological field. As applied within the networked computing environment of FIG. 1, a user of end-user station 110 is prompted via user interface 125 by processor 120 to identify a licensor, licensee, license type and technological field. The user inputs the requested information on user interface 115 and selects type unilateral. The technological field may be input in the form of a patent classification number. Processor 120 caches the license type and technological field in memory 122. Step 210 is thereby completed. Processor 122 forms licensor and licensee company search queries for company database 150 based on the licensor identity and the licensee identity, respectively, and the respective company search queries are transmitted over network 130 from end-user station 110 to server 140 via network interface 125. At server 140, the respective company search queries are applied to company database 150 to generate respective company search results, including respective lists of affiliated legal entities and, for the licensee, global revenue data. The respective company search results are transmitted from server 140 to end-user station 110 via network 130 and network interface 125. Step 220 is thereby completed. Processor 120 forms respective licensor and licensee patent search queries for patent database 160 based on the respective lists of affiliated legal entities and cached technological field. The respective patent search queries are transmitted from end-user station 110 to server 140 via network 130 and network interface 125. If the technological field was not input in the form of a patent classification number, processor 120 replaces the technological field with a corresponding patent classification number in forming the respective patent search queries. At server 140, the respective patent search queries are applied to patent database 160 to generate respective patent search results, including respective patent counts within the corresponding patent classification for which the licensor- and licensee-affiliated legal entities, respectively, are named as an assignee. The licensor patent search result further includes the PSIs of the respective licensor patents within the corresponding patent classification. The licensee patent search result further includes a global licensee patent count (i.e. patent count across all classifications). The configured royalty rate associated with the patent classification is also retrieved from the patent database 160 and applied to one of the search results. The respective patent search results are transmitted from server 140 to end-user station 110 via network 130 and interface 125. Step 230 is thereby completed. At end-user station 110, processor 120 calculates the mean patent strength index (PSI_{avg}) of the licensor patents and the percentage of the licensee's global patent count attributable to the technological field. Processor 120 further multiplies the global revenue data for the licensee by the percentage to estimate the licensee revenue attributable to the technological field. Processor 120 further calculates an exposure rate for the licensee in the technological field in function of the licensor patent count within the technological field, in a manner explained below in greater detail in conjunction with the description of FIGS. 6 and 7. But continuing to focus on FIG. 2 for the time being, processor 120 multiplies the licensee revenue in the technological field by the licensee exposure rate and the royalty rate for the technological field to determine the license fee. Step 240 is thereby completed. The license fee is supplied as an output to the user on user interface 115 with underlying data on which the license fee determination is based, including the parties' respective lists of affiliated legal entities, the licensee global revenue data, the calculated percentage of licensee revenue attributable to the technological field, the calculated exposure rate and the configured royalty rate. The user is provided the opportunity to modify the underlying data. If the user modifies the parties' respective lists of affiliated legal entities, or either of them, the user is warned of the dependency of the licensee revenue attributable to the technological field (if the licensee's list is modified) and licensee exposure rate (if the licensor's list is modified). If the user elects to proceed despite the dependency warning (250), the process returns to Step 230 and the license fee is re-determined. If the user modifies the licensee global revenue, the percentage of licensee revenue attributable to the technological field, the exposure rate algorithm or parameters therefor (as hereinafter described), and the royalty rate, or any of them (260), the process returns to Step 240 and the license fee is re-determined. Attempts by the user to set the percentage of licensee revenue attributable to the technological field or royalty rate below zero percent or above one hundred percent are inhibited. The license fee re-determinations proceed until the user declines the opportunity to modify any of the underlying data. Re-determinations commence upon the user making an affirmative indication, such as a mouse click or a keystroke, after making all desired modifications.

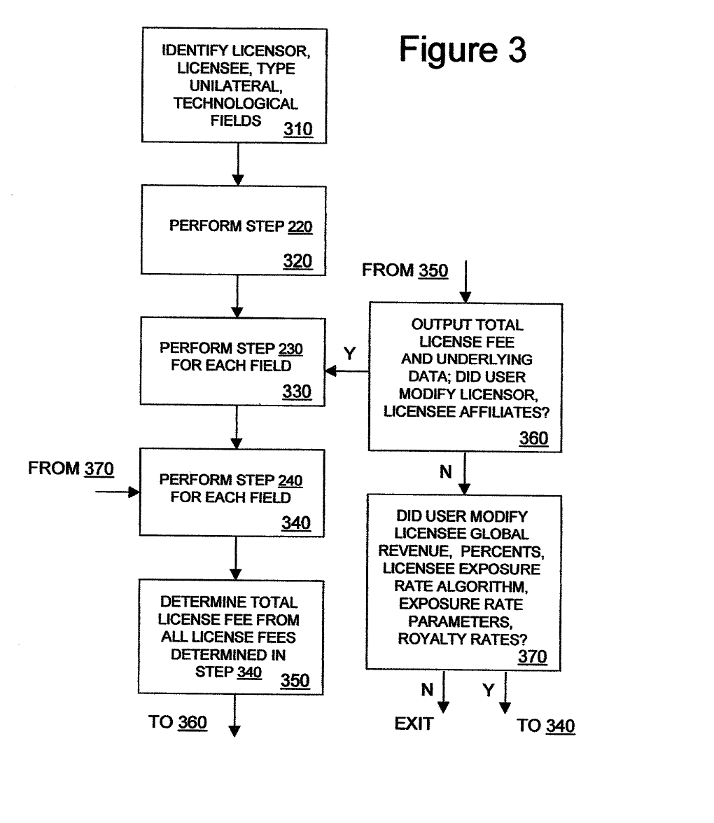

Turning now to FIG. 3, a flow diagram illustrates a method for determining a unilateral patent license fee in multiple technological fields. As applied within the networked computing environment of FIG. 1, a user of end-user station 110 is prompted to identify a licensor, licensee, license type and technological field. The user inputs the requested information and selects type unilateral, only this time the user identifies multiple technological fields (310). The interactions of processor 120 with company database 150 and patent database 160 proceed as described in Step 220 through 240, only this time Steps 230 and 240 are performed for multiple technological fields (320, 330, 340). The “per field” license fees calculated in Step 340 are summed to determine a total license fee (350). The total license fee is supplied as an output to the user with underlying data on which the total license fee determination is based, including the parties' respective lists of affiliated legal entities, the licensee global revenue and, for each technological field, the percentage of licensee revenue attributable, the licensee exposure rate and the royalty rate. The user is provided the opportunity to modify the underlying data. If the user modifies the parties' respective lists of affiliated legal entities, or either of them, the user is warned of the dependency of the licensee revenues attributable to the technological fields (if the licensee's list is modified) and licensee exposure rates (if the licensor's list is modified). If the user elects to proceed despite the dependency warning (360), the process returns to Step 330 and the total license fee is re-determined. If the user modifies the licensee global revenue data, the percentages of licensee revenue attributable to the technological fields, the exposure rate algorithm or parameters therefor (as hereinafter described) and the royalty rates, or any of them (370), the process returns to Step 340 and the total license fee is re-determined. Attempted modifications which would result in the aggregate percent of licensee revenue attributable to the technological fields exceeding one hundred percent are not accepted. Moreover, attempts to set royalty rate below zero percent or above one hundred percent for a given technological field are not accepted. The license fee re-determinations proceed until the user declines the opportunity to modify any of the underlying data.

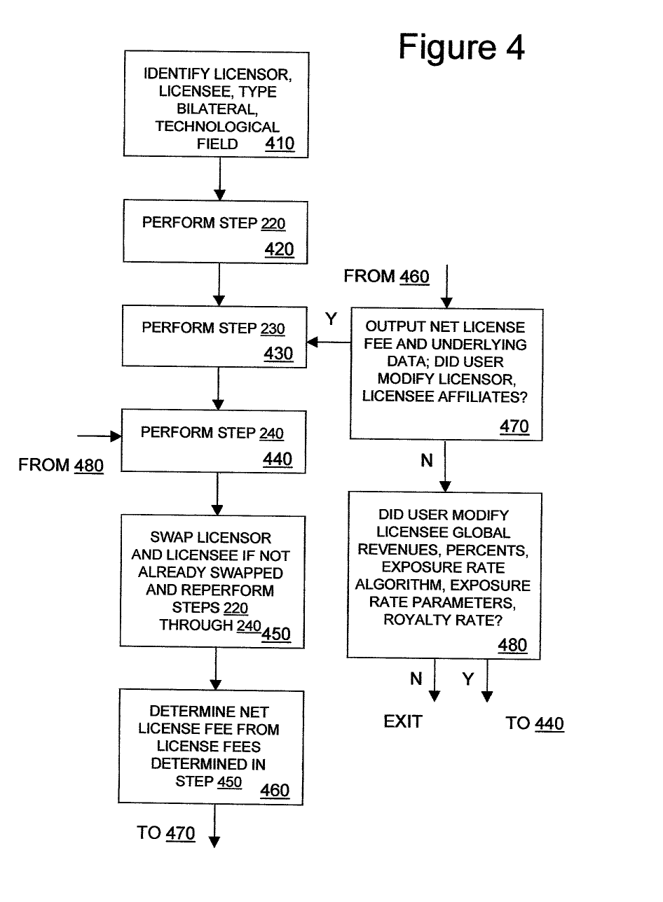

Turning next to FIG. 4, a flow diagram illustrates a method for determining a bilateral patent license fee in a single technological field. As applied within the networked computing environment of FIG. 1, a user of end-user station 110 is prompted to identify a licensor, licensee, license type and technological field. The user inputs the requested information, only this time the user selects type bilateral (410). The interactions of processor 120 with company database 150 and patent database 160 proceed as described in Steps 220 through 240 (420, 430, 440). The licensor and licensee are swapped and Steps 220 through 240 are re-performed (450). The license fee calculated in the second instance of Step 440 for the licensee's reciprocal grant to the licensor is subtracted from the license fee calculated in the first instance of Step 440 for the licensor's grant to the licensee to produce a net license fee, i.e. “balancing payment” (460). The net license fee is supplied as an output to the user with underlying data on which the license fee determination is based, including, the parties' respective lists of affiliated legal entities, respective global revenues, respective percentages of revenue attributable to the technological field, respective exposure rates in the technological field, and the royalty rate in the technological field. The user is provided the opportunity to modify the underlying data. If the user modifies the parties' respective lists of affiliated legal entities, or either of them, the user is warned of the dependency of the revenue attributable to the technological field and exposure rate. If the user elects to proceed despite the dependency warning (470), the process returns to Step 430 and the net license fee is re-determined. If the user modifies the parties' respective global revenues, respective percentages of revenue attributable to the technological field and the exposure rate algorithm or parameters therefor (as hereinafter described), and the royalty rate, or any of them (480), the process returns to Step 440 and the net license fee is re-determined. The net license fee re-determinations proceed until the user declines the opportunity to modify the underlying data.

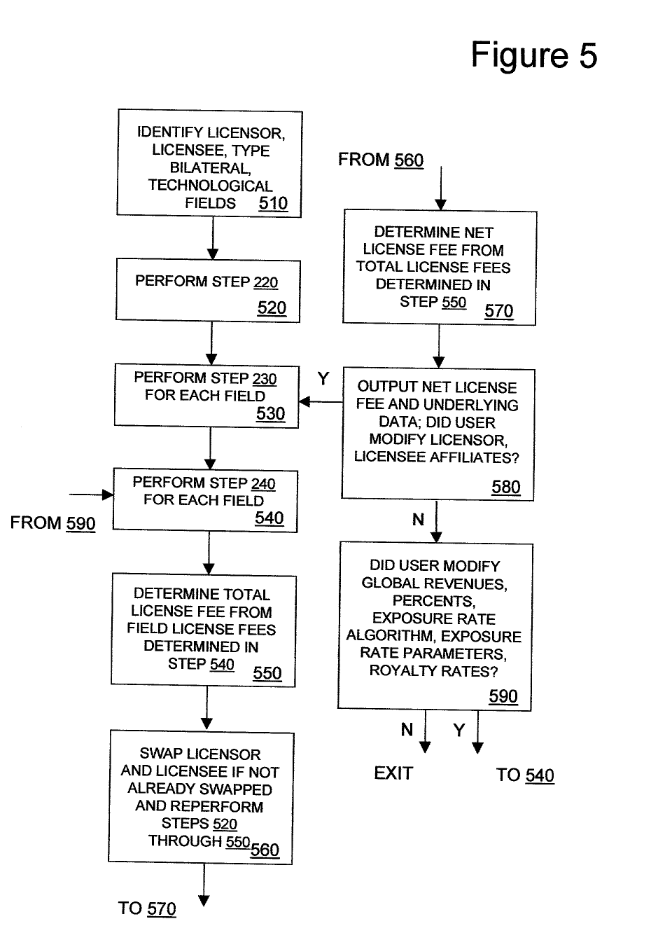

Turning next to FIG. 5, a flow diagram illustrates a method for determining a bilateral patent license fee in multiple technological fields. As applied within the networked computing environment of FIG. 1, a user of end-user station 110 is prompted to identify a licensor, licensee, license type and technological field. The user inputs the requested information, only this time the user selects type bilateral and identifies multiple technological fields (510). The interactions of processor 120 with company database 150 and patent database 160 proceed as described in Step 220 through 240, only this time Steps 230 and 240 are performed for multiple technological fields (520, 530, 540). The “per field” license fees calculated in Step 540 are summed to determine a total license fee (550). The licensor and licensee are swapped and Steps 520 through 550 are re-performed (560). The total license fee calculated in the second instance of Step 540 for the licensee's reciprocal grant to the licensor is subtracted from the total license fee calculated in the first instance of Step 540 for the licensor's grant to the licensee to produce a net license fee, i.e. “balancing payment” (570). The net license fee is supplied as an output to the user with underlying data on which the net license fee determination is based, including, the parties' respective lists of affiliated legal entities, respective global revenues and, for each technological field, the parties' respective percentages of revenue attributable and respective exposure rates, and the royalty rates. The user is provided the opportunity to modify the underlying data. If the user modifies the parties' respective lists of affiliated legal entities, or either of them, the user is warned of the dependency of the revenue attributable to the technological fields and exposure rates. If the user elects to proceed despite the dependency warning (580), the process returns to Step 530 and the net license fee is re-determined. If the user modifies the parties' respective global revenues, respective percentages of revenue attributable to the technological fields, the exposure rate algorithm or parameters therefor (as hereinafter described), and the royalty rates, or any of them (580), the process returns to Step 530 and the net license fee is re-determined. The net license fee re-determinations proceed until the user declines the opportunity to modify the underlying data.

A particularly important feature of the present invention is determination of a patent license fee in function of one or more algorithmically determined exposure rates. In a preferred embodiment, processor 120 determines exposure rates algorithmically through application of one of two user selected algorithms: Algorithmic Exposure Rate (AER) or Weighted Algorithmic Exposure Rate (WAER). The user is afforded the opportunity to specify the algorithm and certain parameters therefor after processor 120 makes a first pass determination of the license fee based on an applied exposure rate (or rates) determined by WAER using configured WAER parameters. The first pass output includes the applied exposure rates and the configured WAER parameters. The user may modify the applied exposure rates implicitly by modifying the WAER parameters and re-determining the license fee using WAER, or may modify the applied exposure rates implicitly by specifying AER and AER parameters and determining the license fee using AER. Re-determinations commence upon the user making an affirmative indication, such as a mouse click or a keystroke, after making all desired modifications.

Referring now to FIG. 6, a graphical illustration of an AER function 600 for application in determining an applied exposure rate is provided. AER is an algorithm for determining an applied exposure rate in a technological field in relation to the licensor's patent count in the technological field. A correlation can be expected between the licensor's number of patents and the licensee's exposure rate due to the following: (i) a correlation can be expected between the licensor's number of patents and the licensee's likelihood of infringement; (ii) a further correlation can be expected between the licensor's number of patents and the revenue scope of any licensee infringement. AER takes advantage of this expected correlation.

The AER function 600 is a linear function bounded at 0% at a minimum patent threshold (pₘᵢₙ) and at a maximum exposure rate (ERₘₐₓ) at a maximum patent threshold (pₘₐₓ). Allowance of a minimum patent threshold greater than zero recognizes that a licensee's exposure rate may be expected to approach zero at some small but non-zero licensor patent count in a technological field. Similarly, allowance of a maximum patent threshold and a corresponding maximum exposure rate recognizes that a licensee's exposure rate may be expected to approach a maximum which may, due to factors such as litigation uncertainties, not reach 100%, at some large licensor patent count in a technological field. The slope of the line between the minimum and maximum thresholds may be considered a per patent exposure rate (pper). The user may specify a maximum exposure rate and any two out of three of the other AER parameters (pₘᵢₙ, pₘₐₓ, pper) and processor 120 will determine an applied exposure rate (ERₐₚₚ) in relation to the licensor's patent count. The maximum patent threshold must be selected to be greater than the minimum patent threshold. The per patent exposure rate must be selected between 0% and ERₘₐₓ and may not be selected such that a resulting minimum patent threshold would be less than zero. The configured AER parameters are preferably ERₘₐₓ=100%, pₘᵢₙ=0, pₘₐₓ=100 and pper=1.0%. AER operation is illustrated in the following examples.

### EXAMPLE 1

### User Defined pₘᵢₙ and pper

The user specifies a maximum exposure rate (ERₘₐₓ) of 100%, a minimum patent threshold (pₘᵢₙ) of five and a per patent exposure rate (pper) of 0.5% for the technological field. The licensor's patent count (PC) in the technological field (e.g. patent classification) is 50. The licensee's applied exposure rate (ERₐₚₚ) in the technological field is

$$\begin{matrix}{ER}_{app} = pper * ( PC - {p}_{min} ) \\ = 0.5 \% * ( 50 - 5 ) \\ = 22.5 \% .\end{matrix}$$

### EXAMPLE 2

### User Defined pₘᵢₙ and pₘₐₓ

The user specifies a maximum exposure rate (ERₘₐₓ) of 100%, a minimum patent threshold (pₘᵢₙ) of 0 and a maximum patent threshold of 400 for the technological field. The licensor's patent count (PC) in the technological field is 50. The licensee's applied exposure rate (ERₐₚₚ) in the technological field is

$$\begin{matrix}{ER}_{app} = {ER}_{max} / [ 1 + [ ( {p}_{max} - PC ) / ( PC - {p}_{min} ) ] ] \\ = 100 \% / [ 1 + [ ( 400 - 50 ) / ( 50 - 0 ) ] ] \\ = 12.5 \% .\end{matrix}$$

### EXAMPLE 3

### User Defined pper and pₘₐₓ

The user specifies a maximum exposure rate (ERₘₐₓ) of 90%, a per patent exposure rate of 1.0% and a maximum patent threshold of 80 for the technological field. The licensor's patent count (PC) in the technological field is 50. The licensee's applied exposure rate (ERₐₚₚ) in the technological field is

$$\begin{matrix}{ER}_{app} = {ER}_{max} - pper * ( {p}_{max} - PC ) \\ = 90 \% - 1.0 \% * ( 80 - 50 ) = 60.0 \% .\end{matrix}$$

Referring finally to FIG. 7, a graphical illustration of a WAER function 700 for application in determining an applied exposure rate is provided. WAER determines an applied exposure rate in a technological field in relation to the licensor's number of patents in the technological field and a mean patent strength index (PSI_{avg}) for the licensor's patents in the field. WAER takes advantage of the fact that a licensee's exposure rate in a technological field can be expected to correlate not only on the number of patents held by the licensor in the field, but also the quality of the licensor's patents in the field.

A patent strength index (PSI) is a measure of the strength of a patent relative to other patents. In a preferred embodiment, a PSI in the range of 0 to 100 is assigned to each patent in relation to the patent's percentile ranking among all patents (i.e. owned or controlled by any party) in the technological field in relation to defined patent strength parameters. Patent strength parameters may include, by way of example, number of references cited, number of later patents citing the patent, number of claims, number of independent claims, minimum number of words in any independent claim, average number of “means” recitations in independent claims, minimum number of “means” recitations in any independent claim, average number of severely limiting words in independent claims, minimum number of severely limiting words in any independent claim, successful reexamination, reissuance, declaration to an industry standardization body, adjudication without an invalidity ruling, adjudication without a noninfringement ruling, adjudication with a validity ruling, adjudicated with an infringement ruling. The relative importance of the patent strength parameters in determining the PSIs may be defined by assigning relative weights (rw₁, rw₂, . . . rwₓ) to the parameters. PSIs are preferably precalculated for all patents and prestored in patent database 160 in association with the patents to which they pertain so as to be available on demand.

The WAER function 700 is a linear function bounded at 0% at a minimum patent threshold (pₘᵢₙ) and at a maximum exposure rate (ERₘₐₓ) at a maximum patent threshold (pₘₐₓ). The slope of the line may be considered the applied per patent exposure rate (apper). The WAER function uses PSI_{avg} calculated for the licensor's patents in the technological field to adjust the applied per patent exposure rate in the technological field upward or downward from a base per patent exposure rate (bpper). The user may define the maximum exposure rate, the minimum patent threshold, the base per patent exposure rate and a per patent exposure rate adjustment threshold (pperaₘₐₓ) and processor 120 will determine the applied per patent exposure rate. Particularly, processor 120 receives the PSIs of the licensor patents within the technological field as part of the licensor patent search result and calculates PSI_{avg} therefrom. For every point PSI_{avg} is below 50 (i.e. the mean), 1/50*pperaₘₐₓ is subtracted from the base per patent exposure rate to determine the applied per patent exposure rate. Similarly, for every point PSI_{avg} is above 50, 1/50*pperaₘₐₓ is added to the base per patent exposure rate to determine the applied per patent exposure rate. The base per patent exposure rate must be selected between 0%+pperaₘₐₓ and 100%−pperaₘₐₓ. The default values are ERₘₐₓ=100%, pₘᵢₙ=0, bpper=1.0% and pperaₘₐₓ=1.0%. WAER operation is illustrated in the following examples.

### EXAMPLE 4

The user specifies a maximum exposure rate (ERₘₐₓ) of 100%, a minimum patent threshold (pₘᵢₙ) of five, a base per patent exposure rate (bpper) of 0.3% and a per patent exposure rate adjustment threshold (pperaₘₐₓ) of 0.5% for a technological field. The licensor's patent count (PC) in the technological field is 100 and processor 120 calculates a mean patent strength index (PSI_{avg}) of 60 for the licensor patents. The licensee's applied exposure rate (ERₐₚₚ) in the technological field is

$$\begin{matrix}{ER}_{app} = [ bpper + ( ( {PSI}_{avg} - 50 ) / 50 ) * {ppera}_{max} ] * ( PC - {p}_{min} ) \\ = [ 0.3 \% + ( 10 / 50 ) * 0.5 \% ] * ( 100 - 5 ) = 38.0 \% .\end{matrix}$$

### EXAMPLE 5

The user specifies a maximum exposure rate (ERₘₐₓ) of 100%, a minimum patent threshold (pₘᵢₙ) of zero, a base per patent exposure rate (bpper) of 0.5%, a per patent exposure rate adjustment threshold (pperaₘₐₓ) of 0.2% for the technological field. The licensor's patent count (PC) in the technological field is 100 and processor 120 calculates a mean patent strength index (PSI_{avg}) of 70 for the licensor patents. The licensee's applied exposure rate (ERₐₚₚ) in the technological field is

$$\begin{matrix}{ER}_{app} = [ bpper + ( ( {PSI}_{avg} - 50 ) / 50 ) * {ppera}_{max} ] * ( PC - {p}_{min} ) = \\ = [ 0.5 \% + ( 20 / 50 ) * 0.2 \% ] * ( 100 - 0 ) = 58.0 \% .\end{matrix}$$

The applied exposure rate can then be readily applied as described at, e.g., Step 240 to determine a license fee for the technological field.

It will be appreciated by those of ordinary skill in the art that the invention can be embodied in other specific forms without departing form the spirit or essential character hereof. The present description is therefore considered in all respects illustrative and not restrictive. The scope of the invention is indicated by the appended claims, and all changes that come within the meaning and range of equivalents thereof are intended to be embraced therein.

I claim:

1. A method for determining patent license fee data, comprising:
inputting on a computer patent license data;
processing the patent license data using an interaction involving the computer to determine patent license fee data; and
outputting on the computer the patent license fee data,
wherein the processing step includes determining algorithmically exposure rate data to be applied in determining the patent license fee data.

2. The method according to claim 1, wherein the processing step includes determining exposure rate data to be applied in determining the patent license fee data in function of a patent count.

3. The method according to claim 1, wherein the processing step includes determining exposure rate data to be applied in determining the patent license fee data in function of a patent strength metric.

4. The method according to claim 1, wherein the processing step includes determining exposure rate data to be applied in determining the patent license fee data in function of a patent count and a patent strength metric.

5. A networked computing system, comprising an end-user station having a user interface, for interacting with a user, and a network interface, for interacting with a network, wherein the end-user station interacts with the user and the network to determine patent license fee data including determining algorithmically exposure rate data to be applied in determining the patent license fee data.

6. The system according to claim 5, wherein the exposure rate data are determined in function of a patent count.

7. The system according to claim 5, wherein the exposure rate data are determined in function of a patent strength metric.

8. The system according to claim 5, wherein the exposure rate data are determined in function of a patent count and a patent strength metric.

9. A computer program having instructions for interacting with an end-user station, a user and a network to determine patent license fee data including determining algorithmically exposure rate data to be applied in determining the patent license fee data.

10. The program according to claim 9, wherein the exposure rate data are determined in function of a patent count.

11. The program according to claim 9, wherein the exposure rate data are determined in function of a patent strength metric.

12. The program according to claim 9, wherein the exposure rate data are determined in function of a patent count and a patent strength metric.

13. A method for determining patent license fee data, comprising:
identifying a patent count;
calculating exposure rate data in function of the patent count;
calculating patent license fee data in function of the exposure rate data.

14. The method according to claim 13, further comprising:
identifying a patent strength metric,
wherein the exposure rate data are calculated in further function of the patent strength metric.

15. A method for determining exposure rate data for application in determining patent license fee data, comprising:
identifying a plurality of exposure rate function parameters;
defining an exposure rate function using the plurality of exposure rate function parameters;
identifying a patent count; and
applying the patent count in the exposure rate function to determine exposure rate data.

16. The method according to claim 15, further comprising:
identifying a patent strength parameter; and
adjusting the exposure rate function using the patent strength parameter prior to applying the patent count in the exposure rate function.

17. The method according to claim 15, wherein the exposure rate function parameters include a minimum patent threshold and a per patent exposure rate.

18. The method according to claim 15, wherein the plurality of exposure rate function parameters includes a per patent exposure rate and a maximum patent threshold.

19. The method according to claim 15, wherein the plurality of exposure rate function parameters includes a minimum patent threshold and a maximum patent threshold.

20. The method according to claim 15, wherein the plurality of exposure rate function parameters includes a maximum exposure rate.

21. The method according to claim 15, wherein the exposure rate function is linear.
